(19) United States
(12) Patent Application Publication
(10) Pub. No.: US 2011/0106594 A1
(43) Pub. Date: May 5, 2011

(54) EXPANDABLE PRODUCT FEATURE AND RELATION COMPARISON SYSTEM

(75) Inventor: Andrew SHIREY, San Francisco, CA (US)

(73) Assignee: CBS INTERACTIVE, INC., San Francisco, CA (US)

(21) Appl. No.: 12/613,158

(22) Filed: Nov. 5, 2009

(51) Int. Cl. G06Q 30/00; G06F 17/30

(52) U.S. Cl. 705/14.4; 707/732; 707/E17.014; 707/723

(57) ABSTRACT

A method of presenting data regarding products is described. Feature categories are assigned to each a product category based on available data. Feature categories may be expanded to display further information about a category and specific attributes within that category. A weighted importance is assigned to each attribute of each feature category based on the available data. Attributes are ranked according to their weighted importance.

### TECHNICAL FIELD

The present disclosure relates generally to the field of e-commerce and, more specifically, to knowledge representation and decision support for a network-based transaction facility such as, for example, an Internet-based comparison shopping facility.

### BACKGROUND

An advantage offered by online communities and network-based transaction facilities (e.g., business-to-business, business-to-consumer and consumer-to-consumer Internet marketplaces and retailers) is that by using such facilities or communities, users may shop from a variety of merchants.

The merchants may offer a variety of products or specialize in one type of product. Some users buy products after searching through the offerings of the various merchants and comparing the products and the prices.

Recently, comparison shopping facilities have developed that list various merchant offerings on one site to aid users in choosing from which merchant they should buy an item. These comparison shopping facilities present items by listing the price and name of the merchant offering the item.

The user may choose items from the listing and go to each merchant's site to learn more about each item or buy the item. Each available item from each manufacturer is listed separately. Thus, a user has to go to the comparison shopping facility either knowing what product to buy beforehand, and compare merchants and prices at the facility, or look at each item separately, by following a link to each merchant's site, to determine if the item is appropriate. Most comparisons performed by comparison shopping sites are based on the merchant's offer price. That is, the result of the comparison shopping is a list of items listed according to the price.

Often, a website displaying items have dedicated web pages, tabs or links containing technical details about that item, in which those web pages, tabs or linked are typically titled, “Specifications”. Traditionally, item specifications are displayed statically in list or table form. For example, a specification on a camera web page may show, “Resolution: 10 megapixels”. Users viewing the specification page may have little or no context in which to interpret this specification information, particularly if they are not familiar with camera technology. Additionally, there are no known web-based specification pages that are interactive with the user and capable of providing substantially useful information to the user, the product developer, and/or the advertising entities.

### SUMMARY OF THE INVENTION

Thus, there is a need for a system and method which provides context to specification and product attribute information to facilitate user understanding of products and ultimately guide purchasing decisions. A method of presenting expanded specification data regarding products meeting this need and others is described. In one embodiment, feature categories are assigned to each product category based on available data. Feature categories may be expanded to display further information about a category and specific attributes within that category. A weighted importance is assigned to each attribute of each feature category based on the available data. Attributes are ranked according to their weighted importance. Thus, specification information is informative, interactive, engaging, and a portal to other features on the site rather than a navigational endpoint.

One benefit of the present disclosure is that it engages the user by providing meaningfully relevant offerings. Expanded specification data provides specification-centric content, rankings, trends, and an invitation for the user to further investigate each of these. Community building is established at the specification-per-category level. Furthermore, these advantages are provided without increased clutter, as the expanded specification can be collapsed to be visually equivalent to current specification page displays.

The present disclosure also provides increased traffic to the product web pages. Expanded specification data greatly increases navigation options from one product page to another product page, including those product pages that are highlighted for popularity and importance. Furthermore, side-door frequented product pages are transformed into navigation portals, creating a two-way street between facet-oriented pages displays products and product pages displaying facets.

The present disclosure further provides for increased direct sales revenue by providing targeted advertising opportunities. The disclosure offers ad delivery hooks against industry-market specification catalog data. Furthermore, advertisers and manufacturers can promote specific products or pages on the product page via sponsored links, sponsored logos, and reuse of other revenue streams on the expanded specification data or specification links.

The present disclosure also provides critical business intelligence and marketing information. For example, user behavior with respect to the expanded specification pages can be tracked. New links can be made formalizing the user engagement experience. Dependence on the internet browser “back” button and on web page “search” functions are reduced, and click-through trends become easier to track. Furthermore, the expanded specification box can be used as a contextually relevant place to present compelling user behavior data.

In one embodiment, a method of presenting data regarding products of a plurality of brands based upon data records stored in at least one computer readable storage medium is described, said data records storing product identification and attribute information, said records being stored in an ontology of products and product categories, said method comprising assigning a weighted importance to a plurality of attribute for at least one product in a product class based on available data in the data records, ranking the plurality of attributes based on the assigned weighted importance, and displaying the rankings via a display screen.

In another embodiment, a method of presenting data regarding products of a plurality of brands based upon data records stored in at least one computer readable storage medium is described, said data records storing product identification and attribute information, said records being stored in an ontology of products and product categories, said method comprising displaying a plurality of attributes within a plurality of feature categories based on available data in the data records in response to a user selection of the feature category, assigning a weighted importance to the plurality of attributes based on available data in the data records, ranking the plurality of attributes based on the assigned weighted importance, and displaying the ranked plurality of attributes.

In one embodiment, the method may further comprise assigning a plurality of feature categories corresponding to a plurality of product features within a product category based on available data in the data records, and assigning a plurality of attributes within the plurality of feature categories based on available data in the data records. In another embodiment, the method may further comprise receiving a plurality of selections from a user indicating a plurality of attributes of importance to the user from the ranked plurality of attributes, generating a customized listing of products in the product category based on the selected attributes of importance, and providing to the user the generated customized listing of products in the product category.

The method may further comprise assigning a weighted importance to the plurality of attributes comprises assigning a score between 0 and 100 to each attribute in a feature category. In another embodiment, the method may further comprise assigning a weighted importance to the plurality of attributes comprises assigning a letter score to each attribute in a feature category. The method may further comprise deriving one or more ranges of values within the feature categories from the data records to determine natural ranges for grouping numerical attributes, and may further comprise presenting a user with one or more sub-ranges of values within the feature categories.

In one embodiment, the weighted importance of a particular attribute is calculated based on the data records of at least one of popularity and user opinions regarding that attribute. In another embodiment, the weighted importance of a particular attribute is calculated based on at least one of total number of user clicks and total number of editor clicks on that attribute. In still another embodiment, the method may further comprise selecting one or more advertisements based on the ranked plurality of attributes, and displaying the one or more advertisements on the display screen.

Still other aspects, features and advantages of the present disclosure are readily apparent from the following detailed description, simply by illustrating a number of exemplary embodiments and implementations, including the best mode contemplated for carrying out the present disclosure. The present disclosure also is capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The present disclosure will be understood more fully from the detailed description given below and from the accompanying drawings of various embodiments of the disclosure, which, however, should not be taken to limit the invention to the specific embodiments, but are for explanation and understanding only.

FIG. 1 is a schematic diagram of an embodiment of a product feature and relation comparison system.

FIG. 2 is a flow diagram of an embodiment of a product feature and relation comparison system.

FIG. 3 is a screen shot that illustrates an embodiment of a method for presenting data regarding products according to an embodiment.

FIG. 4 is a schematic diagram of a system of presenting data regarding products.

FIG. 5 is a block diagram of an architecture for presenting data regarding products.

FIG. 6 is a schematic diagram of an exemplary computer system.

### DETAILED DESCRIPTION

Example embodiments are described herein in the context of a system of computers, servers, and software. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, computing devices, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. It is understood that the phrase “an embodiment” encompasses more than one embodiment and is thus not limited to only one embodiment. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

In general, a system and method of presenting data regarding products is described. The products may be physical products, such as televisions, DVD players, gaming systems, digital cameras, and the like, or digital media products, such as software, audio, video, digital images, and the like. In the following description, for purposes of explanation, numerous specific details are set forth in order to provide a thorough understanding of the exemplary embodiments. It is apparent to one skilled in the art, however, that the present disclosure can be practiced without these specific details or with an equivalent arrangement. In some instances, well-known structures and devices are shown in block diagram form in order to avoid unnecessarily obscuring the preferred embodiment.

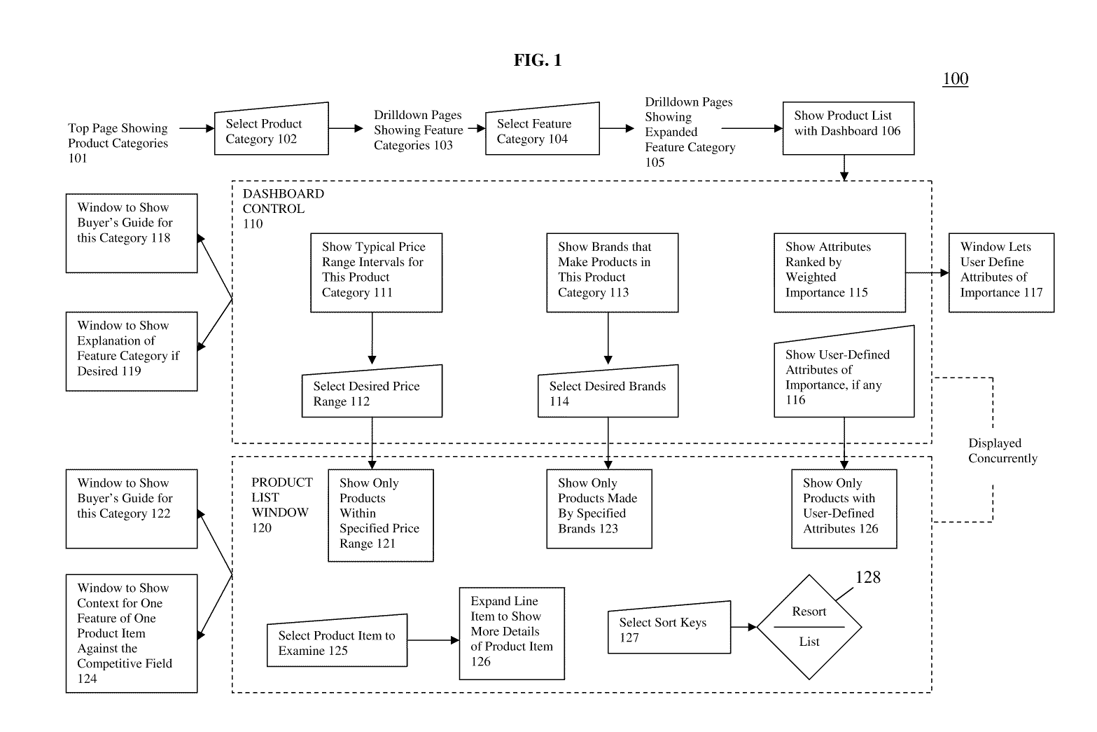

Referring now to the drawings, wherein like reference numerals indicate similar elements throughout the several views, FIG. 1 illustrates an embodiment of a product feature and relation comparison system. The process may be performed by processing logic that may comprise hardware, software, or a combination of both. Note that although the process is described with reference to comparing features of products, it should be understood that the feature comparison methodology described herein may be applied to other types of services.

Referring to FIG. 1, a product feature and relation comparison system 100 is illustrated. Using a computer, a user able to view screens that transition him through the comparison shopping process. Each of the displays represents a page that is displayed in response to some user action. When a user makes a selection or enters information on a page, a request is made to a server over a network to obtain another page. The request may cause the comparison shopping system to perform one or more functions at or under control of the server, with results being provided to user in the form of one or more web pages.

Initially, a user, using an electronic device including, but not limited to, a computer, mobile phone, smartphone, PDA, stand alone or portable video game player, kiosk and the like, displays a first screen, or top page, 101 showing product categories for selection. The electronic device may be configured to communicate with a network, such as a wide area network, for example, the Internet, or a proprietary network. Alternatively, the electronic device may not be in communication with a network.

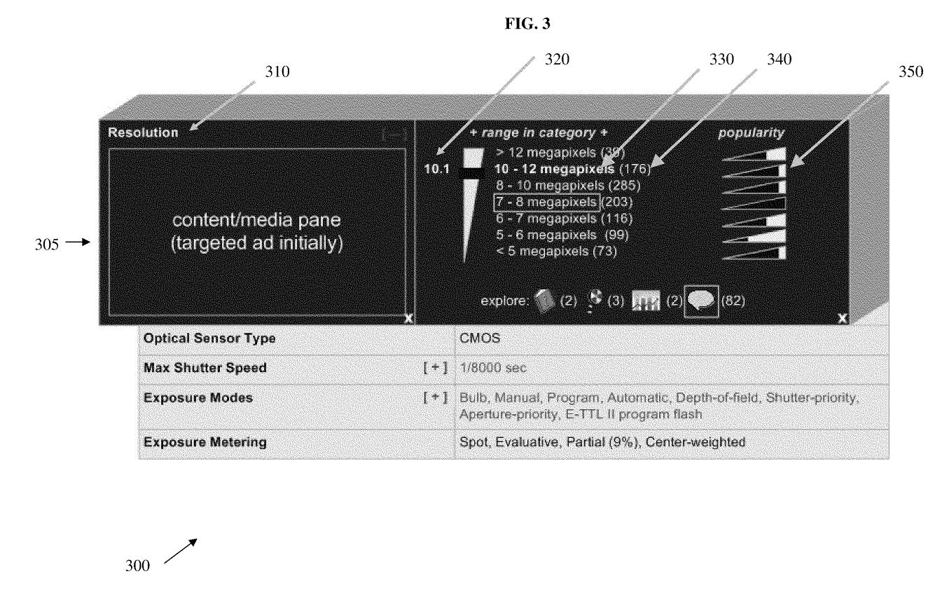

At processing block 102, a user selects a product category via the electronic device. Product categories are determined by types of products and can be, for example, televisions, mobile phones, home audio, home video, DVD players, VCRs, camcorders, cameras, PDAs, desktop and notebook computers, and the like. In response to the user's selection, the electronic device then displays one or more drilldown pages at processing block 103, showing feature categories for each product in that particular product category. Feature categories are defined by features of a selected product category and are many times displayed upon clicking on a “specifications” link or tab. For example, in the product category of digital cameras, the feature categories that may be displayed may be resolution, optical sensor type, max shutter speed, exposure modes, exposure metering, and the like, as shown in FIG. 3, and discussed further below.

Next, at processing block 104 of FIG. 1, the user selects a desired feature category for the product by clicking on a link or tab identifying the feature category. The electronic device then displays drilldown pages 105 showing an expanded feature category which provides further information about the selected feature category. For example, the expanded feature category for the camera resolution may provide a definition of resolution, along with a resolution attribute (for example, 10.1 megapixels), a plurality of resolution attribute ranges (for example, 8-10 megapixels, 10-12 megapixels, etc.), a ranking of the resolution attributes, and the like, as discussed further herein. The expanded feature category may also or alternatively contain information entirely unrelated to the feature category. For example, the expanded feature category for resolution may contain targeted advertising or other unrelated content.

Referring back to FIG. 1, the electronic device displays a product list window 120 with a dashboard control 110 at processing block 106 in response to the user selection of the feature category. The user may have to select a certain number of feature categories at processing block 103 before the electronic device displays the product list window 120.

At processing block 111, the screen shows typical price range intervals for the product category chosen. At processing block 112, the user may select one of the price range intervals shown. In response to the price range selected by a user, the system 100 then filters the product list at processing block 121 to show in window 120 only products within the specified price range.

At processing block 113, the system displays brands or companies that produce the products in the chosen product category (e.g. CANON™ or NIKON™ for cameras). At processing block 114, the user may select one or more of the brands or companies shown on the dashboard control 110. In response to a brand or company selection, the system 100 filters the product list at processing block 123 to show only the products for the chosen category which are made by the specified companies or brands in the product list window 120.

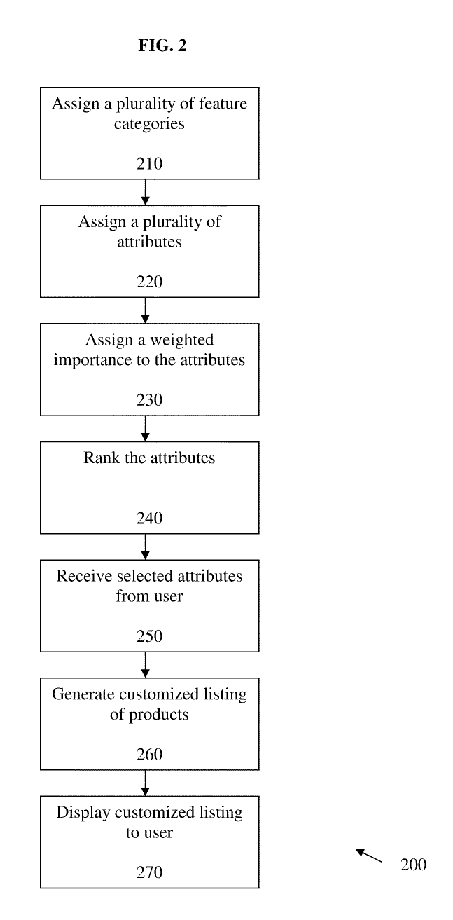

At processing block 115 of the dashboard control 110, the system shows attributes and/or attribute ranges which are ranked by a weighted importance value. Alternatively, the system displays attribute and/or attribute ranges in no particular ranked order, but instead indicated the relative weighted importance value associated with that attribute and/or attribute range. As discussed further with respect to FIG. 2, a weighted importance may be calculated and assigned to an attribute and/or attribute range based on one or more factors, for example, popularity and/or editor(s) opinions, and can be weighted based upon the relative importance of the various factors.

Based on the weighted importance value, the attributes and/or attribute ranges may be displayed and/or ranked in a variety of ways. In one embodiment, the attribute or attribute range with the highest weighted importance is displayed at the top and the lowest weight importance at the bottom, or vice versa. In another embodiment, the weighted importance of each attribute or attribute range can be illustrated graphically, such as, for example, on a sliding scale.

Although not necessary, in an embodiment, as shown as processing block 117, the system displays one or more windows on the display screen which allow the user to select one or more attributes and/or attribute ranges which serve to further define and/or rank the attributes that are important to the user. The selected attributes are stored in a local or remote memory location. In response to the user's selection of these attributes, the dashboard control 110 displays the user-selected attributes of importance, if any, at processing block 116. At processing block 126, the system 100 filters the product list to show in the product list window 120 only those products with the specified attributes. For example, if the user selects a resolution attribute of 10 megapixels in the digital camera product category, the system filters the product list to only include digital cameras with a resolution of 10 megapixels.

The dashboard control 110 may also include windows 118 and 119 in an embodiment. Window 118 shows a user buyer's guides for the product category chosen that may include general information about a product category, i.e. a definition of a product category and how products within that category are used. Window 119 may show a user explanations of individual feature categories if the user wishes to see such explanations. For example, window 119 may include information giving context to the feature category, such as a definition, available attributes within the feature category, and the like.

The product list window 120 may also include windows 122 and 124. Window 122 may show a review on a specific item in the product list window 120, while pop-up window 124 may show the context for one feature of one item in the product list window against the competitive field, or other products in the product category chosen. The feature contextualization is fully described in U.S. Pat. No. 7,246,110, herein incorporated by reference.

At processing block 125, from the product list window, a user may select a specific product item to examine. In response to a selection, the system 100 expands the line item to show more details of the selected product item in processing block 126. The product list window may also be reorganized by selecting sort keys to re-sort the list. At processing block 127, a user may select sort keys such as, for example, price, memory size, or any other product features(s). In response to the selection, at processing block 128, the system 100 re-sorts the list according to the users chosen sort method.

Referring now to FIG. 2, a flowchart 200 of the method according to one embodiment is illustrated. At 210, feature categories corresponding to product features within a product category are assigned based on available data in the data records. Available data may include, for example, features that are important to a product or that occur in all brands of the same product extracted from literature about the product such as articles, reviews, etc. This data may be associated with one or more products, then stored in a database containing one or more data records, each associated with a particular product. The assignment of feature categories to the product may be done automatically or may be manually inserted by an editor, programmer, or other users of the system.

In one embodiment, the data records are stored and organized in an efficient manner through the use of an ontology. The ontology categorizes the products by using attributes that describe and organize the products in the catalog for retrieval. However, the ontology as a whole is divided into one or more levels of categories, with which the attributes are associated. This architecture is described fully in U.S. patent application Ser. No. 12/476,398, filed Jun. 6, 2009, and is herein incorporated by reference in its entirety.

At step 220, a plurality of attributes within the feature categories may be assigned by the product feature and relation comparison system 100 based on available data in the data records. Again, the attributes within the feature categories may be automatically applied by the system or may be manually inserted by an editor, programmer, or other users.

At step 230, a weighted importance value is assigned by system 100 to the attributes based on available data. The available data may include, for example, the number of times the feature is mentioned in product literature from one or more sources or data records. Additionally or alternatively, the weighted importance value of an attribute may be designated based on its popularity and/or importance with product review editors and/or other users of the system. The weighted importance value may be taken as an average among other users and/or editors over a specified or continuous period of time. The weighted importance value may be calculated by, for example, monitoring the number of total users who have searched the site for that attribute or have clicked on that attribute for one or more products. It is contemplated that the system combs metadata, search result hits, and/or other user activity or navigation to determine the weighted importance value for one or more particular attributes.

The weighted importance value may be assigned by the system to be a numerical value between 0 and 100, or other ranges, for example Alternatively, the weighted importance may include a different numerical scale or assigning a letter value to each feature category within a product category, or any other way of signifying a weighted importance value.

The feature categories and weighted importance of each feature category are desirably stored in a database (not shown) for each product category. It will be understood that the method performed in flowchart 200, and similar methods described below, may be edited by an editor. Such editing may, for example, ensure that the representation of the data in the database is correct (e.g., that a product category includes all of the correct feature categories with those categories weighted correctly).

At step 240, the attributes are ranked based on the assigned weighted importance. Thus, for a category such as, for example, digital cameras, the feature categories may include resolution, optical sensor type, max shutter speed, exposure modes, exposure metering, and the like. If the available data indicates that a resolution attribute range of 7-8 megapixels is more popular with users than attributes ranges of 6-7 megapixels and 5-6 megapixels, for example, then the resolution attribute range of 7-8 megapixels will be given higher rankings compared to 6-7 megapixels and 5-6 megapixels. Thus, the resolution attribute ranges of digital cameras may be ranked with 7-8 megapixels first, then 6-7 megapixels, then 5-6 megapixels, and so on

The weighted importance value and/or attribute ranking can be used by a user for a variety of purposes. A user can use the weighted importance value and/or attribute ranking to determine what other users find to be important attributes for that particular product or class of products, what experts and editors suggest as important attributes for that particular product or class of products, what attributes are most popular for that particular product or class of products, and the like. Amongst other reasons, the weighted importance values and/or attribute rankings are advantageous because they provide a user unfamiliar with the technology contextual information in which to view the product or product class. For example, a user who is looking to buy a digital camera, but is unfamiliar with the attributes associated with digital cameras, may see from an expanded resolution specification that cameras with resolutions below 5 megapixels and above 15 megapixels are not popular with other users. Based on this information, the user will be informed from these attributes which can then help the user make a decision on which types of cameras may be of interest to the user.

The weighted importance value and/or attribute ranking can also be used for business intelligence, development, and marketing purposes. For instance, editors of the website can use the weighted importance value and/or attribute ranking information to determine the most popular attributes for a particular product or product class, and focus on those attributes in future product reviews or other website features. Third party companies can also use this information to determine what attributes are most important to users, and to focus on those attributes in advertising and new product development.

After the attributed are ranked, a user selects attributes of importance to him or her from the ranked plurality of attributes at 250. A customized listing of products in the product category is then generated based on the selected attributes of importance 260 which is then provided to the user 270. The products may be selected and provided to the user because they include the user-selected attributes of importance. Products having attributes with comparable rankings may also be provided to the user.

FIG. 3 shows screen shot 300 of an embodiment a method for presenting data regarding products. Expanded feature category 305 for resolution feature category 310 displays additional details about the resolution of a product based on available data in the data records. Resolution attribute 320 may be displayed within attribute range 330, allowing the user to select the range to display a plurality 340 of other products with the same attribute within the same attribute range. Popularity ranking 350 represents the relative popularity of the particular attribute range amongst users. As previously described, popularity ranking 350 may be calculated by, for example, monitoring the number of total users who have searched the site for that attribute or have clicked on that attribute for one or more products. Popularity ranking 350 uses volume-bar graphics to indicate which attributes have received the most attention (i.e. click-through traffic) in a set timeframe, such as over the past four weeks. However, the timeframe may alternatively be ongoing, i.e. from the date of implementation of the monitoring until the current day.

Graphical representations of an attribute's increasing and waning popularity over longer period of time (not shown) may also be accessed and embedded into expanded feature category 305. These representations may also be overlaid with user click-through trends or other long-term trends. These representations reflect the demands and expectations of users over time, and as such, may be used for business intelligence purposes, as described above.

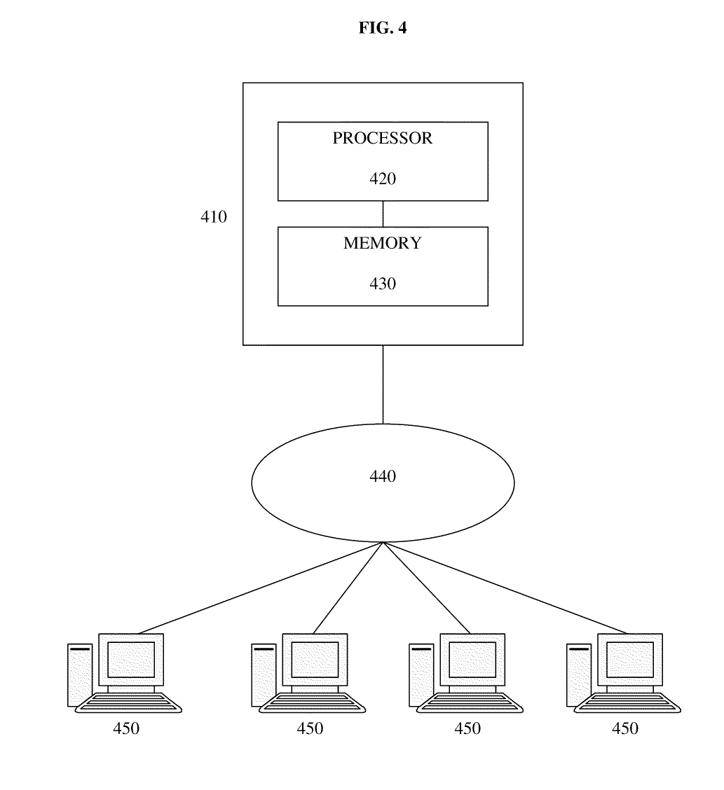

FIG. 4 illustrates server 410 that is connected over network 440 to a plurality of user systems 450. Server 410 includes one or more processors 420 and one or more memories 430, which are in communication with one another. Server 410 is configured to deliver online content to users at the plurality of user systems 450. Server 410 is typically a computer system, and may be an HTTP (Hypertext Transfer Protocol) server, such as an Apache server. Memory 430 may be any type of storage media that may be volatile or non-volatile memory that includes, for example, read-only memory (ROM), random access memory (RAM), magnetic disk storage media, optical storage media, flash memory devices, and/or zip drives. Network 440 may be a local area network (LAN), wide area network (WAN), a telephone network, such as the Public Switched Telephone Network (PSTN), an intranet, the Internet, or combinations thereof. The plurality of user systems 450 may be mainframes, minicomputers, personal computers, laptops, personal digital assistants (PDAs), cell phones, smartphones, dedicated kiosks, and the like. The plurality of user systems 450 are characterized in that they are capable of being connected to network 440. The plurality of user systems 450 include web browsers.

In use, when a user of one of the plurality of user systems 450 wants to, for example, select and transmit attributes of importance to the user in order to receive a customized listing of products, a request to access content is communicated to server 410 over network 440. For example, a signal is transmitted from one of the user systems 450, the signal having a destination address (e.g., address representing the server), a request (e.g., content request), and a return address (e.g., address representing the user system that initiated the request). Processor 420 accesses memory 430 to provide the requested content, which is communicated to the user over network 440. For example, another signal may be transmitted that includes a destination address corresponding to the return address of the client system, and the content responsive to the request.

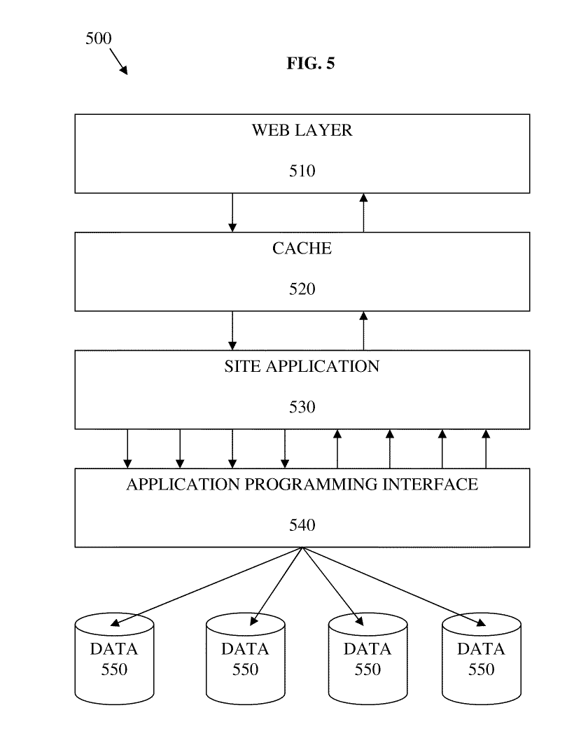

As shown in FIG. 5, system architecture 500 includes web layer 510, cache 520, site application 530, application programming interface 540, and a plurality of data stores 550. It will be appreciated that the system architecture may vary from the illustrated architecture. For example, web layer 510 may directly access data stores 550, the site application may directly access data stores 550, system architecture 500 may not include cache 520, etc., as will be appreciated by those skilled in the art. Web layer 510 is configured to receive user requests to access content through a web browser and return content that is responsive to the user request. Web layer 510 communicates the user requests to cache 520. Cache 520 is configured to temporarily store content that is accessed frequently by web layer 510 and can be rapidly accessed by web layer 510. In one embodiment, cache 520 may be a caching proxy server. Cache 520 communicates the user requests to site application 530.

Site application 530 is configured to update cache 520 and to process user requests received from web layer 510. Site application 530 may identify that the user request is for a page that includes data from multiple sources. Site application 530 can then convert the page request into a request for content from multiple sources and transmits these requests to application programming interface 540. Application programming interface 540 is configured to simultaneously access data from the plurality of data stores 550 to collect the data responsive to the plurality of requests from site application 530. The plurality of data stores 550 may include, for example, catalogue data about different product types (e.g., product specifications, pricing, images, etc.). It will be appreciated that in alternative embodiments only one data store 550 may be provided to store the data.

The data in data stores 550 is provided to application programming interface 540, which provides the content to site application 530. Site application 530 updates cache 520 and delivers the cached content in combination with the accessed content to web layer 510, which delivers browsable content to the user, such as through a product page.

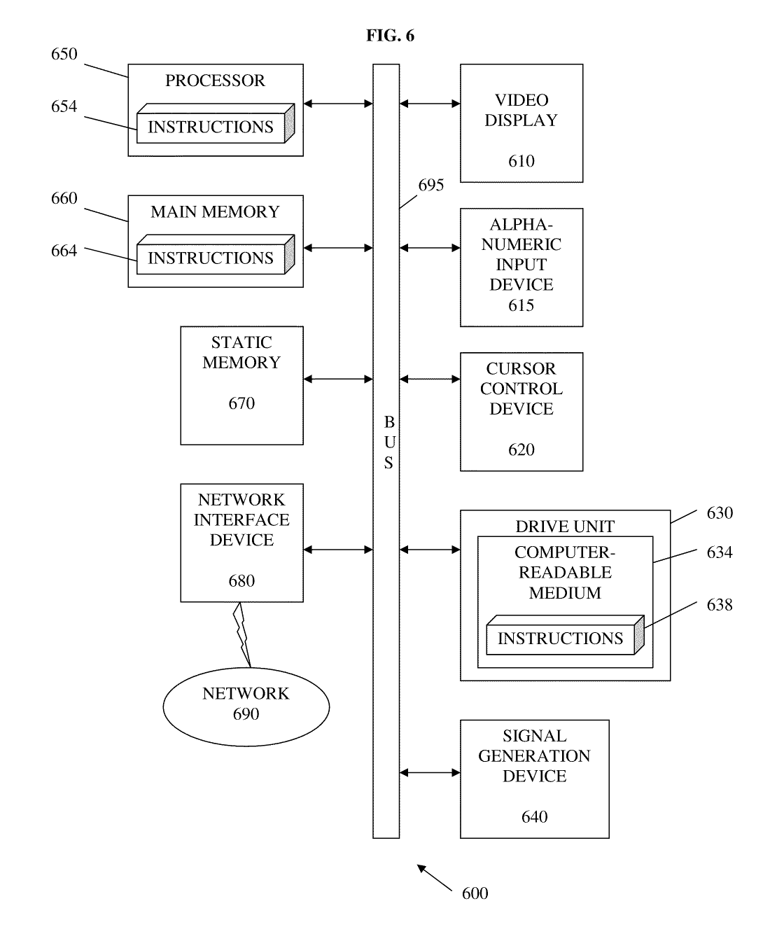

FIG. 6 shows a diagrammatic representation of machine in the exemplary form of computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Exemplary computer system 600 includes processor 650 (e.g., a central processing unit (CPU), a graphics processing unit (GPU) or both), main memory 660 (e.g., read only memory (ROM), flash memory, dynamic random access memory (DRAM) such as synchronous DRAM (SDRAM) or Rambus DRAM (RDRAM), etc.) and static memory 670 (e.g., flash memory, static random access memory (SRAM), etc.), which communicate with each other via bus 695.

Computer system 600 may further include video display unit 610 (e.g., a liquid crystal display (LCD) or a cathode ray tube (CRT)). Computer system 600 also includes alphanumeric input device 615 (e.g., a keyboard), cursor control device 620 (e.g., a mouse), disk drive unit 630, signal generation device 640 (e.g., a speaker), and network interface device 680.

Disk drive unit 630 includes computer-readable medium 634 on which is stored one or more sets of instructions (e.g., software 638) embodying any one or more of the methodologies or functions described herein. Software 638 may also reside, completely or at least partially, within main memory 660 and/or within processor 650 during execution thereof by computer system 600, main memory 660 and processor 650 also constituting computer-readable media. Software 638 may further be transmitted or received over network 690 via network interface device 680.

While computer-readable medium 634 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the disclosure. The term “computer-readable medium” shall accordingly be taken to include, but not be limited to, solid-state memories, and optical and magnetic media.

Thus, in accordance with the present disclosure, specification information is informative, interactive, engaging, and a portal to other features on the site rather than a navigational endpoint. One benefit of the present disclosure is that it engages the user by providing meaningfully relevant offerings. Expanded specification data provides specification-centric content, rankings, trends, and an invitation for the user to further investigate each of these. Community building is established at the specification-per-category level. Furthermore, these advantages are provided without increased clutter, as the expanded specification can be collapsed to be visually equivalent to current specification page displays.

The present disclosure also provides increased traffic to the product web pages. Expanded specification data greatly increases navigation options from one product page to another product page, including those product pages that are highlighted for popularity and importance. Furthermore, side-door frequented product pages are transformed into navigation portals, creating a two-way street between facet-oriented pages displays products and product pages displaying facets.

The present disclosure further provides for increased direct sales revenue by providing targeted advertising opportunities. The disclosure offers ad delivery hooks against industry-market specification catalog data. Furthermore, advertisers and manufacturers can promote specific products or pages on the product page via sponsored links, sponsored logos, and reuse of other revenue streams on the expanded specification data or specification links.

The present disclosure also provides critical business intelligence and marketing information. For example, user behavior with respect to the expanded specification pages can be tracked. New links can be made formalizing the user engagement experience. Dependence on the internet browser “back” button and on web page “search” functions are reduced, and click-through trends become easier to track. Furthermore, the expanded specification box can be used as a contextually relevant place to present compelling user behavior data.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present disclosure has been described in relation to particular examples, which are intended in all respects to be illustrative rather than restrictive. Those skilled in the art will appreciate that many different combinations of hardware, software, and firmware will be suitable for practicing the present disclosure.

Moreover, other implementations of the disclosure will be apparent to those skilled in the art from consideration of the specification and practice of the disclosure described herein. Various aspects and/or components of the described embodiments may be used singly or in any combination. It is intended that the specification and examples be considered as exemplary only, with a true scope and spirit of the disclosure being indicated by the following claims.

What is claimed is:

1. A method of presenting data regarding products based upon data records stored in at least one computer readable storage medium, said data records storing product identification and attribute information, said records being stored in an ontology of products and product categories, said method comprising:
assigning a weighted importance to a plurality of attributes for at least one product in a product class based on available data in the data records;
ranking the plurality of attributes based on the assigned weighted importance; and
displaying the rankings via a display screen.

2. The method of claim 1, further comprising:
assigning a plurality of feature categories corresponding to a plurality of product features within a product category based on available data in the data records; and
assigning a plurality of attributes within the plurality of feature categories based on available data in the data records.

3. The method of claim 2, further comprising:
receiving a plurality of selections from a user indicating a plurality of attributes of importance to the user from the ranked plurality of attributes;
generating a customized listing of products in the product category based on the selected attributes of importance; and
providing to the user the generated customized listing of products in the product category.

4. The method of claim 2, wherein assigning a weighted importance to the plurality of attributes comprises assigning a score between 0 and 100 to each attribute in a feature category.

5. The method of claim 2, wherein assigning a weighted importance to the plurality of attributes comprises assigning a letter score to each attribute in a feature category.

6. The method of claim 2, further comprising:
deriving one or more ranges of values within the feature categories from the data records to determine natural ranges for grouping numerical attributes.

7. The method of claim 6, further comprising:
presenting a user with one or more sub-ranges of values within the feature categories.

8. The method of claim 1, wherein the weighted importance of a particular attribute is calculated based on the data records of at least one of popularity and user opinions regarding that attribute.

9. The method of claim 1, wherein the weighted importance of a particular attribute is calculated based on at least one of total number of user clicks and total number of editor clicks on that attribute.

10. The method of claim 1, further comprising:
selecting one or more advertisements based on the ranked plurality of attributes; and
displaying the one or more advertisements on the display screen.

11. The method of claim 1, wherein at least one of the products is digital media.

12. A method of presenting data regarding products based upon data records stored in at least one computer readable storage medium, said data records storing product identification and attribute information, said records being stored in an ontology of products and product categories, said method comprising:
displaying a plurality of attributes within a plurality of feature categories based on available data in the data records in response to a user selection of the feature category;
assigning a weighted importance to the plurality of attributes based on available data in the data records;
ranking the plurality of attributes based on the assigned weighted importance; and
displaying the ranked plurality of attributes.

13. The method of claim 12, further comprising displaying a plurality of feature categories corresponding to a plurality of product features within a product category based on available data in the data records in response to a user selection of the product category.

14. The method of claim 13, further comprising:
deriving one or more ranges of values within the feature categories from the data records to determine natural ranges for grouping numerical attributes.

15. The method of claim 14, further comprising:
presenting a user with sub-ranges of values within feature categories for filtering product data to be presented.

16. The method of claim 12, wherein assigning a weighted importance to the plurality of attributes comprises assigning a score between 0 and 100 to each attribute in a feature category.

17. The method of claim 12, wherein assigning a weighted importance to the plurality of attributes comprises assigning a letter score to each attribute in a feature category.

18. The method of claim 12, wherein the weighted importance of a particular attribute is calculated based on the data records of at least one of popularity and user opinions regarding that attribute.

19. The method of claim 12, wherein the weighted importance of a particular attribute is calculated based on at least one of total number of user clicks and total number of editor clicks on that attribute.

20. The method of claim 12, further comprising:
selecting one or more advertisements based on the ranked plurality of attributes; and
displaying the one or more advertisements on a display screen.

21. The method of claim 12, wherein at least one of the products is digital media.
